(19) United States
(12) Patent Application Publication
(10) Pub. No.: US 2017/0125831 A1
(43) Pub. Date: May 4, 2017

(54) FUEL CELL CATHODE SWITCHING FOR AIRCRAFT APPLICATIONS

(71) Applicant: Parker-Hannifin Corporation, Cleveland, OH (US)

(72) Inventors: James GASNER, Arlington, TX (US); Shane NICHOLSON, Rhome, TX (US)

(21) Appl. No.: 15/335,842

(22) Filed: Oct. 27, 2016

Related U.S. Application Data
(60) Provisional application No. 62/249,452, filed on Nov. 2, 2015.
(60) Provisional application No. 62/320,825, filed on Apr. 11, 2016.

(51) Int. Cl. H01M 8/04746; B64D 37/32; B64D 41/00; H01M 8/04302; H01M 8/04225

(52) U.S. Cl. CPC H01M 8/04753; H01M 8/04302; H01M 8/04225; B64D 41/00; B64D 37/32; H01M 2250/20; B64D 2041/005

(57) ABSTRACT

An aircraft fuel cell power system includes multiple cathode reactant supply sources to supply oxidant under varied environmental conditions and system requirements during operation.

This application claims the benefit of the filing date of U.S. Provisional Patent Application No. 62/249,452 filed Nov. 2, 2015, and of U.S. Provisional Patent Application No. 62/320,825 filed Apr. 11, 2016.

### TECHNICAL FIELD

The present invention relates to the field of aircraft fuel cell systems, and particularly to control of and switching between multiple cathode reactant supply sources to supply oxidant, either air or pure oxygen, or combinations thereof, under varied flight conditions.

### BACKGROUND

A number of systems on board an aircraft require a reliable and continuous power supply. In addition to the engine driven generation of electrical power, fuel cell systems are used to provide electrical power. Several fuel cells are typically combined in a fuel cell stack to generate the desired power.

Conventional fuel cells require a source of hydrogen for the anode side of the fuel cell and a source of oxidant, either oxygen or air, for the cathode side of the fuel cell. Oxygen depleted air exhausted from the fuel cell can be used as an extinguishing agent, for example, for fire suppression.

### SUMMARY

In a first aspect of the invention, there is provided a fuel cell power system for an aircraft that includes at least one fuel cell having an oxidant supply inlet to the fuel cell; a first oxidant supply source containing oxygen; a second oxidant supply source containing air; a controlled valve fluidly connected to the first and second oxidant supply sources and the oxidant supply inlet to direct oxidant from one or both oxidant supply sources to the oxidant supply inlet; and a controller connected to the controlled valve and configured to control flow of oxidant to the oxidant supply inlet of the fuel cell based on at least one of the system monitored parameters, such as pressure, temperature, oxygen content, humidity, and flow demand of the fuel cell.

The fuel cell further includes a power outlet for providing electrical power to the aircraft; and a cathode exhaust outlet for providing an inert stream with reduced or depleted oxygen concentration for use as an extinguishing agent.

The controlled valve may be a proportional valve and mixes the flow from the first oxidant supply source and the second oxidant supply source.

The first oxidant supply source may be connected to a pressurized oxygen supply tank. The second oxidant supply source may be connected to at least one bleed air source of the aircraft.

The controller may be configured to initiate operation of the fuel cell by controlling flow of oxygen from the first oxidant supply source.

In an embodiment of the fuel cell system, the controller is configured to control flow of air from the first oxidant supply source to the oxidant supply inlet and to switch to the second oxidant supply source to cause an inert stream from the cathode exhaust outlet to flow as an extinguishing agent for cargo hold fire suppression or as an inerting gas for fuel tanks.

### BRIEF DESCRIPTION OF THE DRAWINGS

FIG. 1 is a schematic diagram of an exemplary fuel cell power system in accordance with the present invention.

FIG. 2 is a logic diagram for operating the fuel cell system supplied by multiple cathode reactant sources.

FIG. 3 is a control diagram for monitoring the conditions of the fuel cell system and controlling the operation of the fuel cell system.

### DETAILED DESCRIPTION

Electrochemical devices such as fuel cells are becoming increasingly recognized as viable and economical means of replacing conventional power generation systems with clean, reliable, and quiet energy technologies. The aerospace industry, for example, is developing proton exchange membrane (PEM) fuel cell systems (FCS) for widespread use on commercial aircraft to generate auxiliary power during in-flight electrical emergencies and oxygen-depleted air (ODA) for fire suppression.

While the fuel cell systems (FCS) and methods are described herein as being particularly useful on aircraft and aerospace vehicles, they are also useful in other transportation vehicles and in stationary applications. When deployed, these systems are required to start-up quickly and reliably in a variety of challenging operating environments.

One of the primary advantages of the aircraft FCS described herein as compared to contemporary FCS architecture is the ability to select and/or mix cathodic supplies to manage changing operational modes and environments. Airborne systems are a relatively new application to the industry that require novel approaches to overcome unique conditions that arise from altitude pressure changes, environmental conditions, and certification requirements.

The FCS used to provide electrical power and/or ODA to an aircraft needs to function under varied environmental and system requirements during operation. In order to provide electrical power quickly, i.e., within seconds, at altitude, the FCS is typically started on stored compressed oxygen, or oxidant. When aircraft supplied compressed air is available, the FCS can be switched over from compressed oxygen to compressed air to increase run time while minimizing oxygen consumption and overall storage requirements. When supplying ODA to the aircraft for inerting or fire suppression purposes, the FCS is required to operate on compressed air exclusively. These two modes of operation require a means to control multiple cathode supply gases to support the dual functions of the FCS.

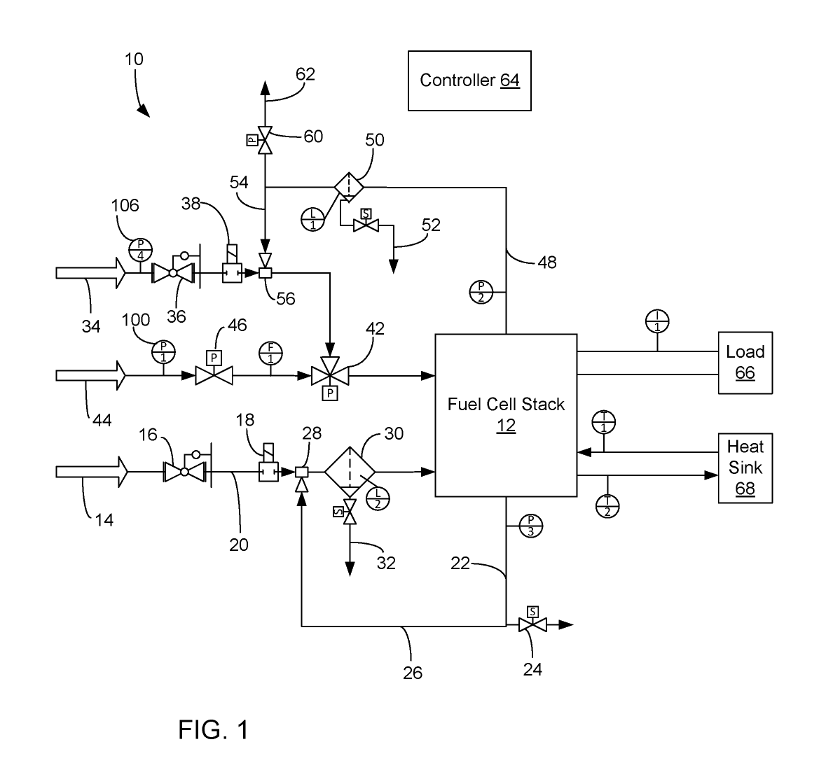

FIG. 1 is a schematic diagram of an exemplary fuel cell power system 10. The exemplary fuel cell system described herein is useful with polymer electrolyte membrane (PEM) fuel cells, but may be used with other types of fuel cells, including but not limited to solid oxide (SOFC), molten carbonate (MCFC), direct methanol (DMFC), alkaline (AFC), phosphoric acid (PAFC).

The fuel cell system 10 includes two oxidant supply sources to the cathode side of the fuel cell stack 12. A source of pressurized oxygen gas 34, typically a high pressure tank, provides oxygen gas through a pressure regulator 36 to an injector 38 that injects a controlled amount of oxygen gas through an oxygen input line 40 to a diverter valve 42. The fuel cell system 10 further includes an air supply source 44 to supply air containing oxygen to the cathode side of the fuel cell stack 12. The air for the supply source 44 may be provided by an air compressor for pressurizing incoming air from, for example, the bleed air generated by the aircraft engines, the aircraft environmental control system, external air, cabin air, cargo air, or any other appropriate source. The compressed air flows through a flow/pressure control valve 46 to diverter valve 42, which delivers the oxidant to the cathode side of the fuel cell stack 12.

The diverter valve 42 can be a discrete valve that allows either cathode supply source to be selected, or it can be a proportional valve to allow transition or mixing of the reactants. The function can be accomplished by utilizing a single valve such as a three-way flow valve, or a combination of valves sequenced properly. Transition from one cathode supply to the other is accomplished by balancing the flow and pressure to the fuel cell during operation. Selection of cathode is achieved prior to start of the FCS, or by matching reactant pressure prior to switching while operating.

The fuel cell system includes an oxidant recirculation system. Oxygen that is not consumed over the cathode catalyst to produce electrical current passes through the cathode flow fields to push liquid water, if any, out of the cathode side of the fuel cell stack in a cathode output line 48. The cathode effluent flows to a water separator 50 that directs liquid water to a drain line 52 and returns humidified oxygen containing gas via recirculation line 54 to an ejector 56 that directs humidified oxygen containing gas to the cathode side of the fuel cell stack 12.

The FCS 10 is configured to allow isolation of the reactants in the case of recirculation of the cathode oxygen. By use of passive recirculation through an ejector 56, the need to prevent backflow through these devices while operating on air is achieved using the diverter valve 42.

When air is used as the oxidant supply source, the cathode effluent may be made up of oxygen depleted air, containing almost exclusively nitrogen and carbon dioxide. The oxygen depleted air may be exhausted from the system through exhaust line 62 that includes pressure valve 60, or may be used as a fire extinguishing agent by conveying the oxygen depleted air through line 62 as an extinguishing agent supply source to a fire suppression distribution system.

The fuel cell system 10 includes a source of hydrogen gas 14, typically a high pressure tank, which provides hydrogen gas through a pressure regulator 16 to an injector 18 that injects a controlled amount of hydrogen gas to the anode side of the fuel cell stack 12 on an anode input line 20. The hydrogen gas that is not consumed over an anodic catalyst to produce electrical current passes through anode flow fields to push liquid water, if any, out of the anode side. An anode effluent, containing humidified hydrogen gas, is output from the anode side of the fuel cell stack on an anode output line 22. The anode effluent is provided to a recirculation line 26 that recirculates the anode effluent to ejector 28 to provide recirculated hydrogen gas back to the anode input of the fuel cell stack 12. Humidified hydrogen gas and liquid water flow through ejector 28 and into a water separator 30 that directs liquid water to drain line 32 and returns humidified hydrogen gas to the anode side to keep the anode side of the PEM moist to support proton conductivity.

Reliability requirements in aviation drive the need for FCS components to be relatively simple, such as the passive recirculation ejectors 28 and 56. In a preferred embodiment, there are no moving parts to fail as a function of use. Active motor driven pumps are relatively complex and may not provide the level of reliability for an emergency power system that spends a majority of the time in a dormant state.

As understood by those skilled in the art, nitrogen cross-over from the cathode side of the fuel cell stack 12 dilutes the hydrogen gas in the anode side of the stack, affecting fuel cell performance. Therefore, it is necessary to periodically purge the anode effluent gas from the anode side through purge valve 24 to reduce the amount of nitrogen in the anode side.

FCS 10 includes controller 64, which is configured to control mixing of the oxidant supply reactants based on different system monitored properties to allow reactant conditioning prior to delivery to the fuel cell stack. The properties of the reactants include temperature, oxygen content, water vapor content, and pressure boosting during power transients. Controller 64 monitors sensors and controls the effectors while performing system control algorithms. The controller 64 makes control decisions based on at least inputs of mode selection, altitude, pressure, temperature, electrical load current, voltage, and run time. Heat sink 68 is used to control the temperature of the fuel cell stack 12. The fuel cell stack 12 supplies electrical power to the load 66.

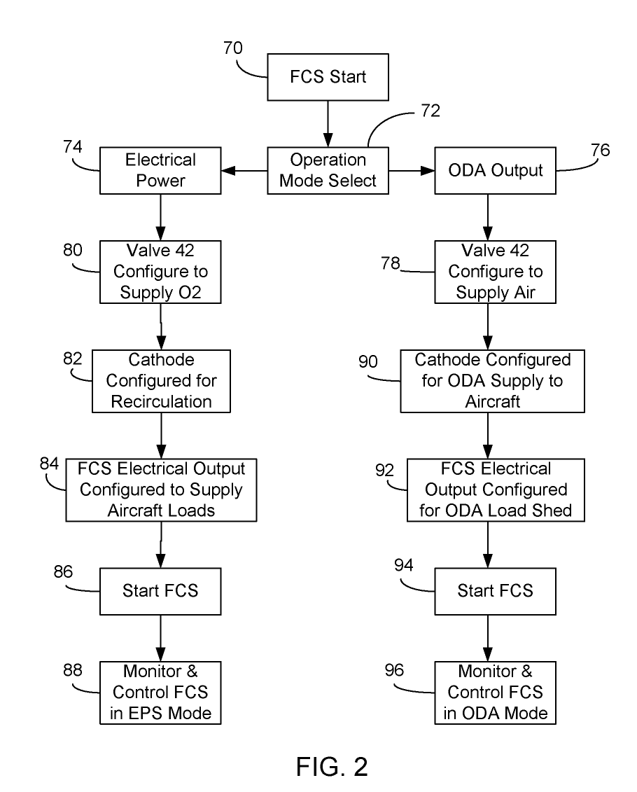

Referring to FIG. 2, a logic diagram by which controller 64 controls operation of the FCS 10 is shown. The FCS 10 is initiated by the aircraft to start (70), and interrogates for the operational mode (72) to start to provide the required output requested. Depending on the electrical power (74) or ODA system (76) mode requirement, the system is configured to start and operate using air or oxygen as the oxidant supply to the cathode.

Emergency power system (EPS) mode configures the cathode supply to start using oxygen, and the diverter valve 42 is switched to supply only oxygen (80). The system is configured to use cathode recirculation (82), and the fuel cell outlet is kept closed to support recirculation. At 84, the fuel cell will supply DC power to the power conditioning system 66 which supplies appropriate DC or AC power to the aircraft. The controller 64 coordinates the power up of the system, configuration, start-up (86) and operation of the system while performing monitoring, control, and communication to the aircraft (88).

When compressed air from the aircraft becomes available, the cathode oxidant supply can be transitioned at 78 to operate from air exclusively, or mix air and oxygen to control the fuel cell in a desired setting by controlling diverter valve 42. At 90, the cathode is configured for supplying ODA to the aircraft for inerting or fire suppression purposes. The FCS electrical output is configured for ODA load shed (90). The controller 64 coordinates the power up of the system, configuration, start-up (94) and operation of the system while performing monitoring, control, and communication to the aircraft (96). Using oxygen in support of the air allows some recirculated water vapor from the fuel cell to be used for humidification. In the mixing setting, the fuel cell can be configured by the controller 64 to exhaust some of the fuel cell cathode exhaust out of the system at flow control valve 60 to prevent nitrogen buildup in the cathode.

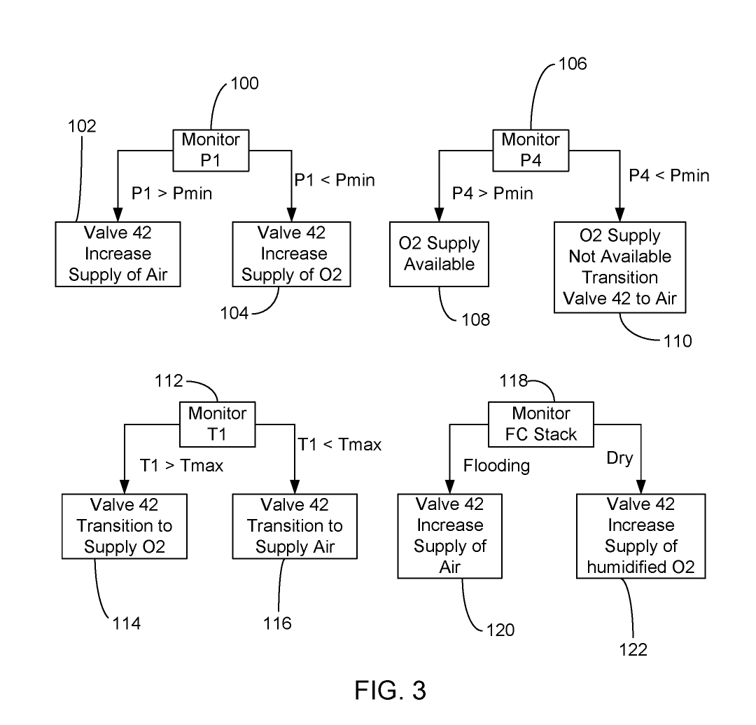

FIG. 3 illustrates simplified control decision diagrams for the fuel cell cathode supply that further describes the monitoring and control functions of FIG. 2. The position of diverter valve 42 depends on the system operational mode, and is determined by monitoring various parameters within the FCS 10 by controller 64.

Monitoring the pressure P1 of compressed air supply (100) in the emergency electrical power mode allows the controller 64 to position the diverter valve 42 to increase the supply of air (102) or oxygen (104) depending on the availability of the aircraft supply air. Introducing more dry air into the cathode is one method of drying the fuel cell stack 12 if flooding conditions exist, and extending the run time of the fuel cell 12 over oxygen only supply.

Oxygen supply pressure P4 at pressure regulator 36 is monitored (106) by the controller 64. Monitoring P4 in the emergency electrical power mode allows the controller to position diverter valve 42 to increase the dependency on cathode air (110) as the oxygen supply (108) depletes.

The fuel cell stack coolant inlet temperature T1 is monitored (112) and controlled using heat sink 68. T1 has a maximum value to prevent damage to the fuel cell, and can be varied by the controller 64 to control water balance of the fuel cell as a function of temperature. The aircraft requires operation over a wide temperature band, from ground to maximum altitude which can vary from an ambient −56° C. to 40° C. Heat rejection from the fuel cell system 12 to the ambient environment requires in some cases increasing the fuel cell system operational temperature to maximize heat transfer. Near the ground on a hot day the temperature difference in the ambient air and the fuel cell operating temperature is smaller, therefore the system needs to increase the fuel cell stack temperature. The cathode air used in the fuel cell is typically very dry and the fuel cell system operates at a lower temperature, 60° C. for example, to manage water balance. In the EPS mode the controller can transition to oxygen (114) via diverter valve 42 and operate on oxygen or a mixture of oxygen and air (116) to increase the operating temperature of the system that will also be water balanced for the fuel cell stack membranes. Operation on increased amounts of recirculated oxygen will allow water vapor back into the incoming cathode reactant and allow high operating temperatures.

The controller 64 can monitor the fuel cell stack (118) health for drying or flooding and control the balance between air (120) and oxygen (122) to control the incoming mixture using diverter valve 42.

The ODA mode of the fuel cell system, if selected, configures the cathode supply to operate on air only. Diverter valve 42 would only allow air into the fuel cell where the controller would then control the cathode stoichiometric ratio to 1.8 or less to provide the required 11° A oxygen content fuel cell exhaust from exhaust valve 62 to the area of the aircraft to be inerted with the ODA. The electrical output of the fuel cell stack would be configured to direct the DC power to a load to shed the energy generated as a byproduct of creating ODA.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A fuel cell power system for an aircraft, comprising:
at least one fuel cell having an oxidant supply inlet to the fuel cell;
a first oxidant supply source comprising oxygen;
a second oxidant supply source comprising air;
a controlled valve fluidly connected to the first and second oxidant supply sources and the oxidant supply inlet to direct oxidant from one or both oxidant supply sources to the oxidant supply inlet; and
a controller connected to the controlled valve and configured to control flow of oxidant to the oxidant supply inlet of the at least one fuel cell based on at least one system monitored parameter chosen from among pressure, temperature, oxygen content, humidity, and flow demand of the fuel cell, and combinations thereof.

2. The fuel cell power system as in claim 1, wherein the fuel cell includes
a power outlet for providing electrical power to the aircraft; and
a cathode exhaust outlet for providing an inert stream with reduced or depleted oxygen concentration for use as an extinguishing agent or inerting agent.

3. The fuel cell power system as in claim 1, wherein the controlled valve is a proportional valve configured to mix the flow from the first oxidant supply source and the second oxidant supply source.

4. The fuel cell power system as in claim 1 wherein the second oxidant supply source is connected to at least one bleed air source of the aircraft.

5. The fuel cell power system of claim 1, wherein the controller is configured to initiate operation of the fuel cell by controlling flow of oxygen from the first oxidant supply source.

6. The fuel cell power system of claim 2, wherein the controller is configured to control flow of air from the first oxidant supply source to the oxidant supply inlet and cause an inert stream from the cathode exhaust outlet to flow as an extinguishing agent to an aircraft cargo hold.

7. The fuel cell power system of claim 2, wherein the controller is configured to control flow of air from the first oxidant supply source to the oxidant supply inlet and cause an inert stream from the cathode exhaust outlet to flow as an inerting agent to an aircraft fuel tank.
